(19) United States
(12) Patent Application Publication
(10) Pub. No.: US 2008/0049958 A1
(43) Pub. Date: Feb. 28, 2008

(54) PIVOT DEVICE

(76) Inventor: Marc Bingaman, Monterey, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 11/466,365

(22) Filed: Aug. 22, 2006

(51) Int. Cl. H04R 1/02

(52) U.S. Cl. 381/334

(57) ABSTRACT

The present invention provides an apparatus for securing a pivoting device to abase location. The device includes a base plate, a clamping assembly, a pivot post rotationally coupled to the base plate and removably coupled to the clamping assembly. The clamping assembly is also secured to a base location, such as the tower portion of a sport boat, such as a ski boat or wakeboard boat. The base plate is secured to a sound-emitting device. The pivot post allows the sound-emitting device to be rotated about the clamping assembly.

### REFERENCE TO PENDING APPLICATIONS

This application is not based upon any pending domestic or international patent application.

### REFERENCE TO MICROFICHE APPENDIX

This application is not referenced in any microfiche appendix.

### BACKGROUND OF THE INVENTION

1. Field of the Invention

The present invention generally relates to a pivot device. More particularly, the present invention relates to a pivoting device for securing a detachable audible sound emitting device thereto.

2. Background

Music has become a very important part the boating culture. In particular, personal watercraft, such as ski boats and wakeboard boats, are commonly outfitted with external speakers so that music can be played during the operation of the craft. These speakers are typically permanently fixed to a portion of the boat. One such position is the tower portion of the craft.

One disadvantage to the prior art external speaker systems is that due to being fixed in a permanent position, the direction of the music is also fixed, usually toward the back portion of the watercraft. When a person moves away from the direction of the music, the quality of the music is negatively impaired or is lost entirely.

Accordingly, there is a need to create a device for securing a detachable audible sound emitting device to a nautical vessel that addresses the needs set out above.

### SUMMARY OF THE INVENTION

The present invention satisfies the needs discussed above. The present invention generally relates to a pivot device. More particularly, the present invention relates to a pivoting device for securing a detachable audible sound emitting device thereto.

One aspect of the present invention provides for a pivoting device having generally a base plate, a pivot post rotatably coupled to the base plate and a clamping assembly. The clamping assembly is removably secured to the pivot post by way of a locking device, such as a locking pin. The clamping assembly is also secured to a base location, such as a water sport vehicle tower. Those skilled in the art will recognize that the water sport vehicle tower is illustrative and is not meant to be limiting.

Various items can be secured to the base plate, such as an audible sound emitting device, namely a speaker. Due to the clamping assembly being secured to the base location and the rotational ability of the base plate, the sound emitting device is capable of projecting sound in multiple directions.

One aspect of the clamping assembly comprises a top clamp and bottom clamp that can be coupled to form a cavity. The cavity can be dimensioned to receive that portion of the nautical vessel by which the inventive pivoting device is secured. The top claim and bottom clamp can be configured to include an insert to adjust the dimensions of the cavity to conform to various portions of the nautical vessel.

One aspect of the base plate includes having a cavity therein. The pivot post is coupled to a detent assembly which is located within a cavity in the base plate. The detent assembly allows the base plate to rotate around the clamping assembly via the pivot post.

One aspect of the present invention provides for transmitting sound on a nautical vessel. This is comprised of a securing pivoting device, such as the inventive device as set out above, which attaches to a nautical vessel. Then a detachable audible sound emitting device that emits audible sound is secured to the pivoting device. Due to the rotational ability of the pivoting device, the sound emitting device is capable of projecting audible sound to the bow, stem, starboard and port sides of the nautical vessel.

Further features of the present invention will be apparent to those skilled in the art upon reference to the accompanying drawings and upon reading the following description of the preferred embodiment.

### BRIEF DESCRIPTION OF THE DRAWINGS

FIG. 1 is a perspective view of an embodiment of the present invention;

FIG. 2 is an expanded perspective view of an embodiment of the present invention as shown in FIG. 1;

FIG. 3 is a cross-sectional view the embodiment of the present invention as shown in FIG. 1;

FIG. 4 is a perspective view of an embodiment of the pivot post aspect of the present invention;

FIG. 5 is a top view of the embodiment of the pivot post aspect of the present invention as shown in FIG. 4;

FIG. 6 is a bottom view of the embodiment of the pivot post aspect of the present invention as shown in FIG. 4;

FIG. 7 is a perspective view of an embodiment of the base plate aspect of the present invention;

FIG. 8 is a cross-sectional view along line AA of the embodiment of the base plate aspect of the present invention as shown in FIG. 7;

FIG. 9 is a perspective view of an embodiment of the top clamp aspect of the present invention;

FIG. 10 is a side view of the embodiment of the top clamp aspect of the present invention as shown in FIG. 9;

FIG. 11 is a bottom view of the embodiment of the top clamp aspect of the present invention as shown in FIG. 9;

FIG. 12 is a perspective view of an embodiment of the bottom clamp aspect of the present invention;

FIG. 13 is a cross-sectional view along line BB of the embodiment of the bottom clamp aspect of the present invention as shown in FIG. 12;

FIG. 14 is a bottom view of the embodiment of the bottom clamp aspect of the present invention as shown in FIG. 12;

FIG. 15 is a perspective view of an embodiment of the bottom clamp insert aspect of the present invention;

FIG. 16 is a perspective view of an additional embodiment of the bottom clamp aspect of the present invention having a groove to receive the embodiment of bottom clamp insert as shown in FIG. 15;

FIG. 17 is a perspective view of an embodiment of the top clamp insert aspect of the present invention; and

FIG. 18 is a perspective view of an additional embodiment of the top clamp aspect of the present invention having a groove to receive the embodiment of top clamp insert as shown in FIG. 17.

### DETAILED DESCRIPTION OF THE PREFERRED EMBODIMENTS

Before explaining the present invention in detail, it is to be understood that the invention is not limited to the preferred embodiments contained herein. The invention is capable of other embodiments and of being practiced or carried out in a variety of ways. It is to be understood that the phraseology and terminology employed herein are for the purpose of description and not of limitation.

The present invention satisfies the needs discussed above. The present invention generally relates to a pivot device, and more particularly, to a pivoting device for securing a detachable audible sound emitting device to a base location. In the following discussion, the general practice of the invention will be discussed with particular reference to emitting audible sounds in the outdoors. However, it is to be understood that these uses of the invention are simply exemplary uses and should not be considered as limiting.

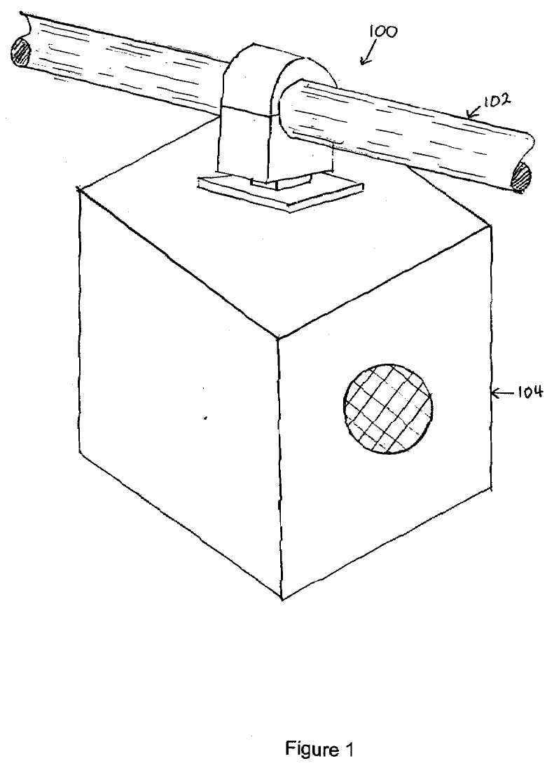

As shown in FIG. 1, an embodiment 100 of the inventive pivot device is disclosed. The embodiment 100 is shown secured around a tubular member 102 and to an audible sound emitting device 104. While this embodiment is shown secured around a tubular member 102 that is circular, such is for illustrative purposes and is not meant to be limiting. Further, the terms “audible sound emitting device” or “sound emitting device” refer to those devices that produce sound such as one or more speakers.

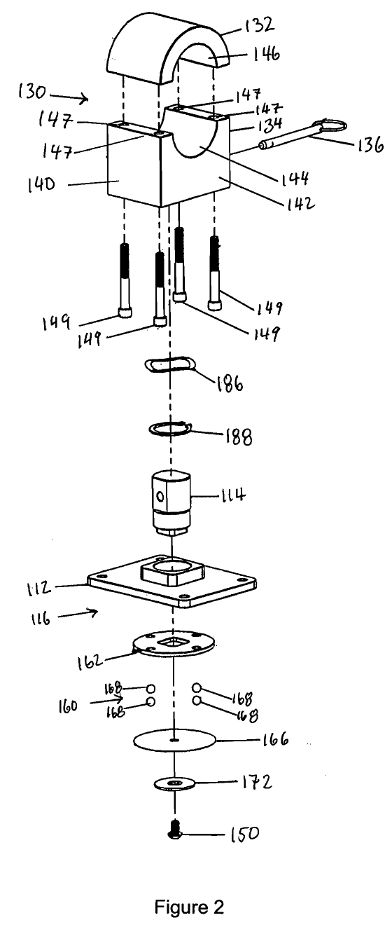

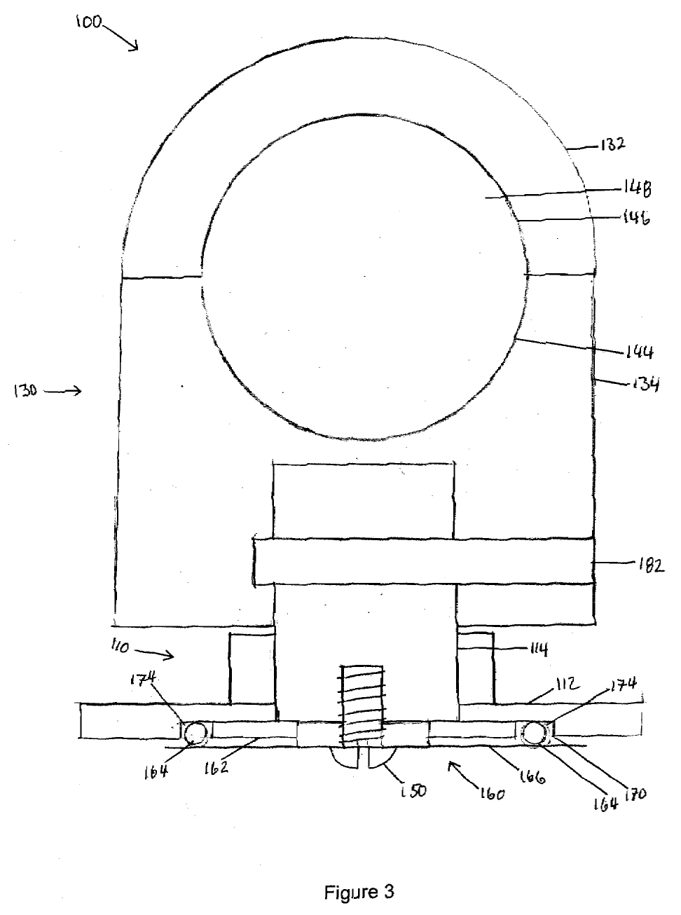

As shown in FIGS. 2 and 3, embodiment 100 is disclosed in further detail. Embodiment 100 comprises a base mount assembly 110 in rotation communication with a clamping assembly 130. The base mount assembly 110 includes a base plate 112 being in rotation communication with a pivot post 114. In operation, base mount assembly 110 is secured to audible sound emitting device 104. Clamping assembly 130 is secured to tubular member 102. Due to the rotational ability of base mount assembly 110 around clamping assembly 130, the attached sound emitting device 104 is capable of rotational movement with respect to tubular member 102

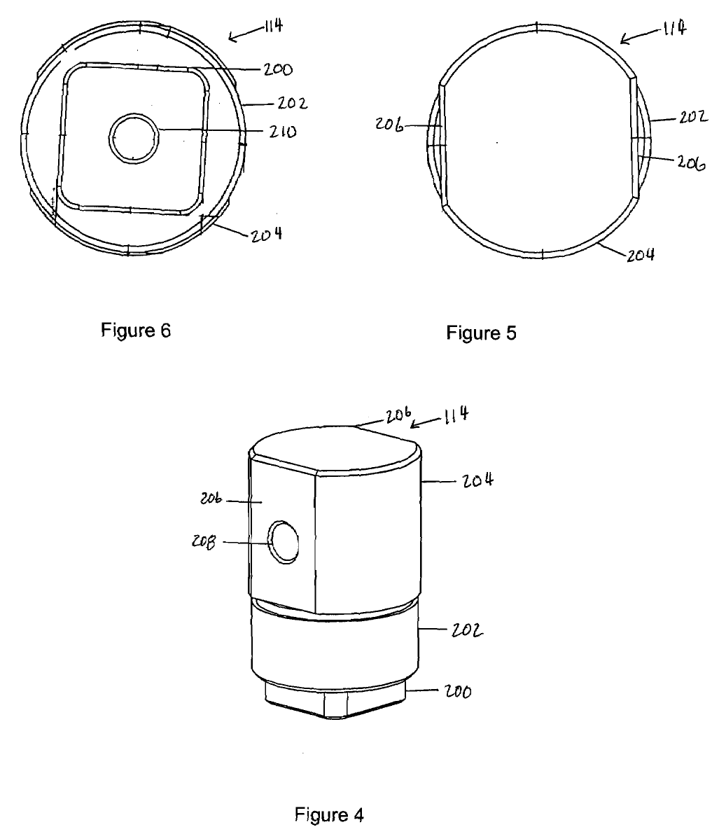

An embodiment of pivot post 114 is shown in FIGS. 4-6 and comprises a lower portion 200 a middle portion 202 and an upper portion 204. A detent assembly bore 210 is located within lower portion 200. Middle portion 202 is circular to allow for rotational movement. Upper portion 204 has two opposing straight side 206, and a locking device bore 208. Those skilled in art will recognize that the configuration of upper portion is illustrative and not meant to be limiting.

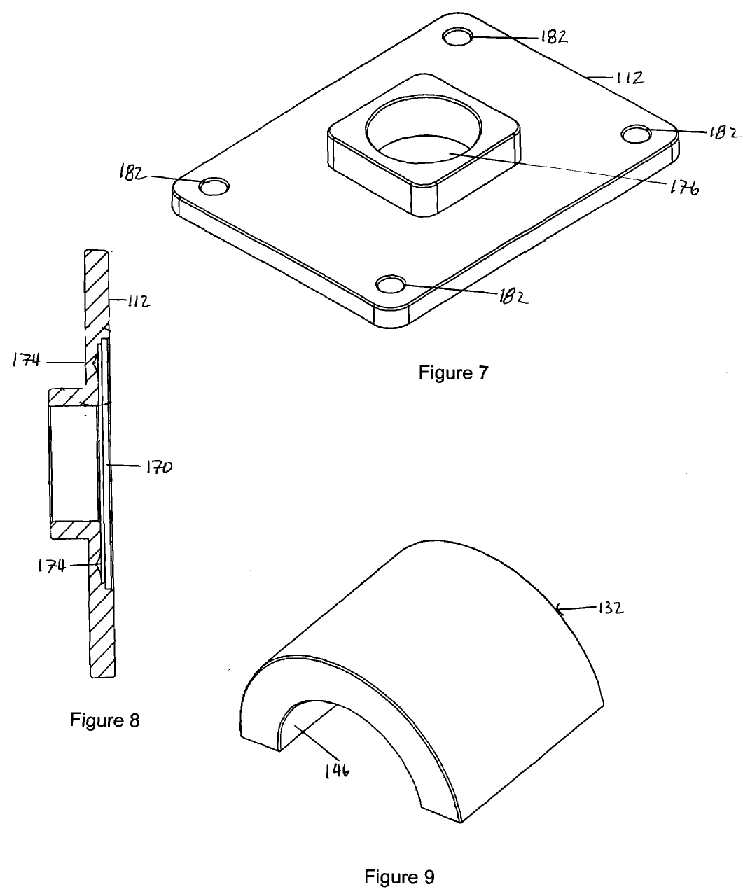

An embodiment of base mount assembly 10 is disclosed in further detail, as shown in FIGS. 7-8. This embodiment includes a base plate 112 being in rotation communication with a pivot post 114. Base plate 112 has a plurality of securing openings 182 in order to secure an audible sound emitting device 104 or other item, and pivot post opening 176. Lower portion 200 of pivot post 114 is positioned within pivot post opening 176 and rotatably secured to base plate 112 by detent assembly 160.

A detent assembly 160 allows pivot post 114 to rotate about base plate 112. Detent assembly 160 includes a plurality of ball bearings 164 being positioned between a guide plate 162 and a spring disk 166. Guide plate 162 has a plurality of openings 168 therein, one for each ball bearing 164.

Guide plate 162 is located within a cavity 170 located along the bottom side of base plate 112. Cavity 170 includes a plurality of indentations 174 which act as a detent mechanism for the restraint of ball bearings 164. Guide plate 162 and spring disk 168 are secured inline with pivot post 114 by screw 150. A washer 172 can be used to aid in securing spring disk 166.

When pivot post 114 rotates, ball bearings 164 are moved out of indentations 174 and into openings 168 and rotated until they encounter another indentation 174. At this point, pivot post 114 is not free to rotate until additional force is applied thereto.

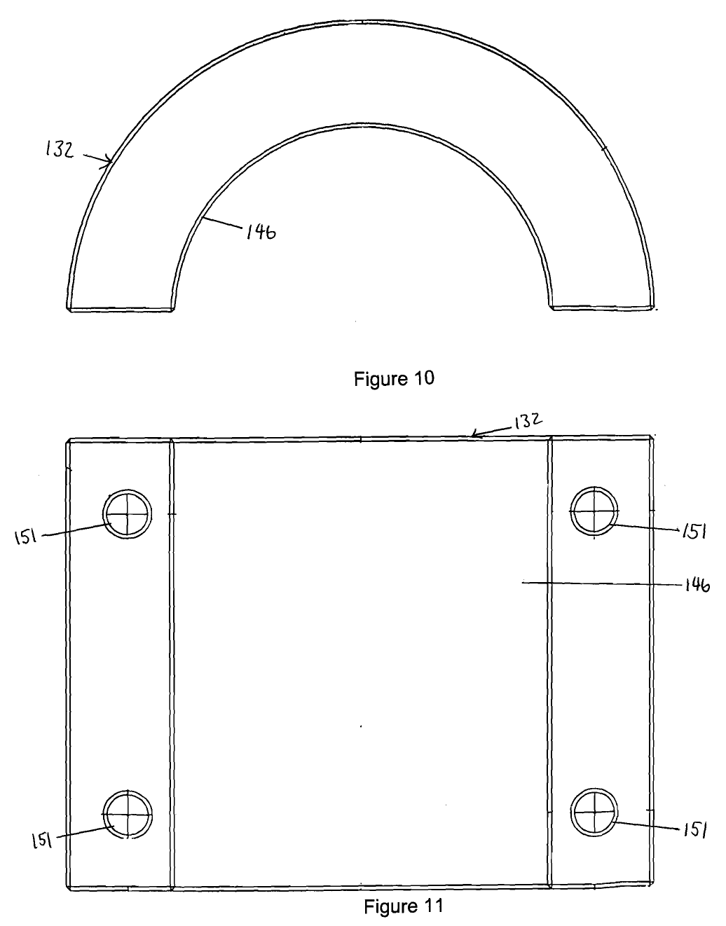

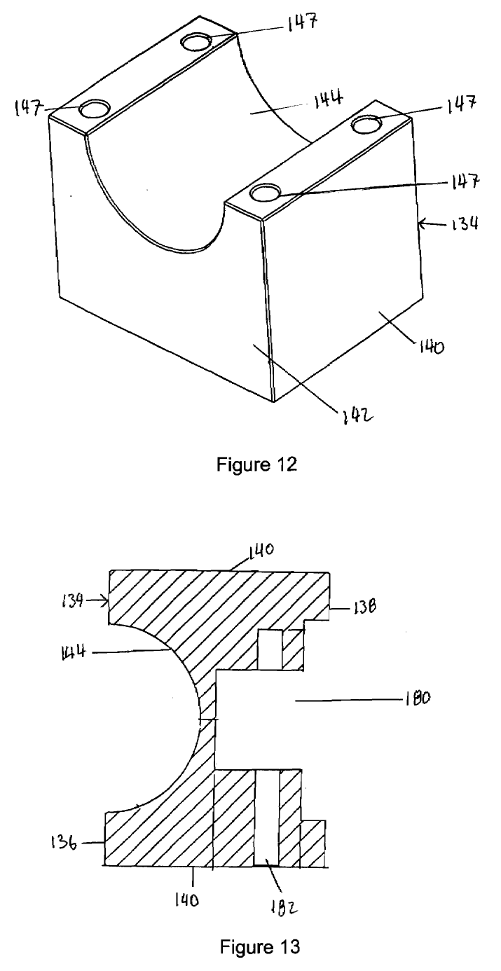

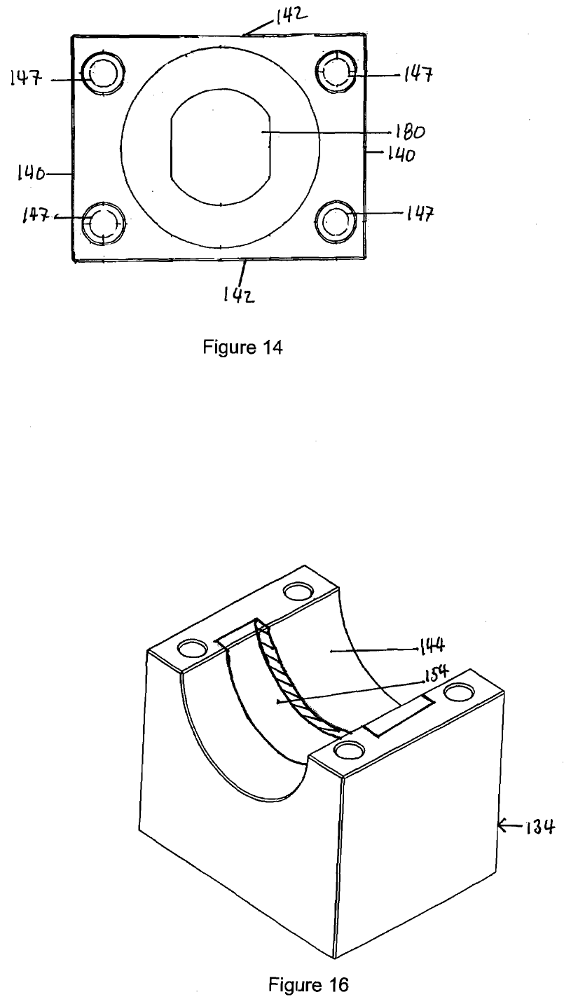

An embodiment of clamping assembly 130 is disclosed in further detail, as shown in FIGS. 9-14. This embodiment includes a top clamp portion 132 removably secured to a bottom clamp portion 134. Top clamp portion 132 is dimensioned in an approximate half-cylindrical configuration, having a cylindrical top inner surface 146. Bottom clamp portion 134 is dimensioned in an approximately rectangular configuration having a top side 136, a bottom side 138, opposing end walls 140 and opposing side walls 142. A semi-cylindrical indentation defining a cylindrical bottom inner surface 144 is located along the top side 136.

Top clamp portion 132 and bottom clamp portion 134 are dimensioned and configured such when the two clamp portions are in communication, a circular opening 148 is defined there through. While both clamp portions are defined as having semi-cylindrical surfaces defining a circular opening, such is illustrative and not meant to be limiting. Further, those skilled in the art would recognize that other geometrical shapes, such as rectangular, may be utilized with the inventive pivot device.

Clamping assembly 130 is secured to tubular member 102 by fitting top clamp portion 132 and bottom clamp portion 134 around tubular member 102 and within the circular opening 146. Opening 146 is dimensioned to provide a secure fit for tubular member 102 to prevent rotation of embodiment 100 around tubular member 102.

Top clamp 132 is secured to bottom clamp portion 134 by screws 149. Screws 149 extend through bottom clamp portion 134 via screw bores 147 and are threadedly mated with top clamp portion 132 via screw holes 151.

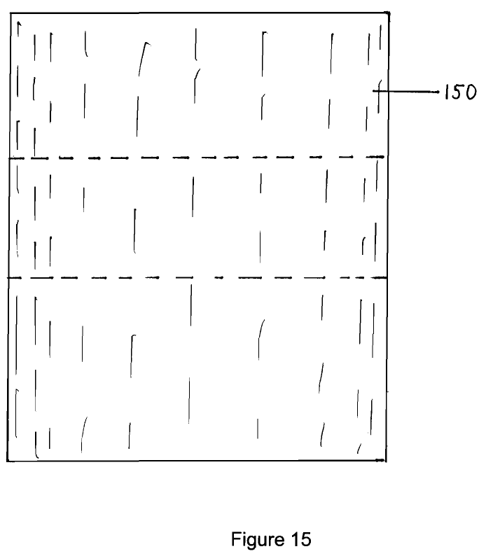

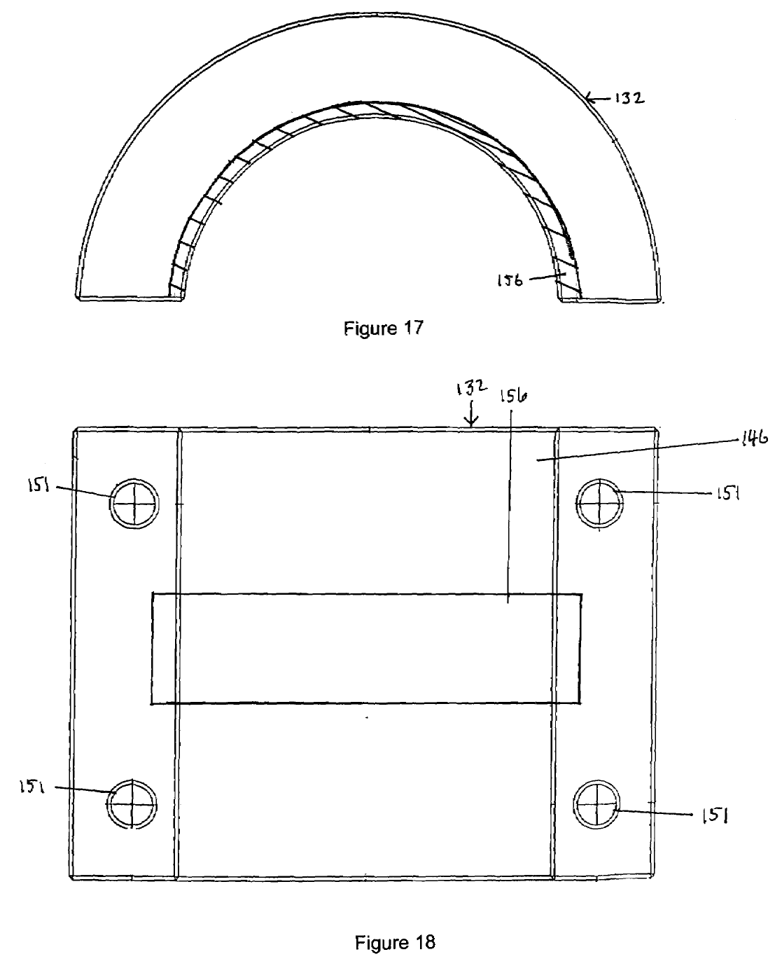

Another embodiment of clamping assembly 130 is illustrated in FIGS. 15-18, and provides for inserts 150, 152 to be communication with top and bottom inner surfaces 144, 146. These inserts 150, 152 are secured to the inner surfaces by way of grooves 154, 156 therein, and can be dimensioned to allow various tubular members or other base locations.

Pivot post 114 is removably in communication with bottom clamp portion 134. A pivot post cavity 180 is located in the bottom side of the bottom clamp portion 134. Pivot post cavity 180 is dimensioned to receive upper section 204 of pivot post 114. The pivot post 114 is coupled to the clamping assembly 130 by a locking device 136. As illustrated in the Figures, locking device 136 is a quick release pin 138 that is inserted into a bore 182 located within bottom clamp portion 134.

By having the base mount assembly 110 being removable from clamping assembly 130, a user is able to easily remove and later replace the audible sound emitting device 104.

While the invention has been described with a certain degree of particularity, it is understood that the invention is not limited to the embodiments set forth herein for purposes of exemplification, but is to be limited only by the scope of the attached claims or including the full range of equivalency to which each element thereof is entitled.

We claim:

1. A pivoting device comprising:
a base plate;
a pivot post rotatably coupled to said base plate; and
a clamping assembly removably coupled to said pivot post.

2. The pivoting device of claim 1, wherein a detachable device that emits audible sound is coupled to said pivoting device.

3. The pivoting device of claim 2, wherein said detachable device that emits audible sound is coupled to said base plate.

4. The pivoting device of claim 1, wherein said base plate is further defined as having cavity and a detent assembly disposed in the cavity, wherein said detent assembly is rotatably secured to said pivot post.

5. The pivoting device of claim 4, wherein said detent assembly is further comprised of a spring disk, at least two ball bearings and circular guide plate.

6. The pivoting device of claim 1, wherein said clamping assembly is divided into a top clamp and bottom clamp that can be coupled.

7. The pivoting device of claim 6, wherein said clamping assembly has a smooth tubular inner cavity surface.

8. The pivoting device of claim 6, wherein said clamping assembly has a grooved tubular inner cavity surface.

9. The pivoting device of claim 8, wherein a removable insert can be aligned with said grooved tubular inner cavity surface.

10. The pivoting device of claim 1, wherein said pivoting device is made of a non-corrosive material.

11. The pivoting device of claim 1, further comprising a locking device for securing said pivot post to said clamping assembly.

12. The pivoting device of claim 11, wherein said locking device for securing said pivot post to said clamping assembly is a pin.

13. A pivoting device comprising:
a base plate having a detachable device that emits audible sound is coupled thereto, said base plate having cavity;
a detent assembly disposed in the cavity;
a pivot post rotatably coupled to said detent assembly;
a clamping assembly removably coupled to said pivot post; and
a locking device for securing said pivot post to said clamping assembly.

14. The pivoting device of claim 13, wherein said locking device for securing said pivot post to said clamping assembly is a pin.

15. The pivoting device of claim 13, wherein said detent assembly is further comprised of a spring disk, at least two ball bearings and circular guide plate.

16. The pivoting device of claim 13, wherein said clamping assembly is divided into a top clamp and bottom clamp that can be coupled.
